(19) United States
(12) Patent Application Publication
(10) Pub. No.: US 2014/0155238 A1
(43) Pub. Date: Jun. 5, 2014

(54) Multiple Blank Carton Former and Carton Production Method

(71) Applicant: Delkor Systems, Inc., St. Paul, MN (US)

(72) Inventors: Ronald Scott Thompson, White Bear Lake, MN (US); Thomas Partridge, Inver Grove Heights, MN (US); Adam Koller, Minneapolis, MN (US)

(73) Assignee: Delkor Systems, Inc., St. Paul, MN (US)

(21) Appl. No.: 14/096,473

(22) Filed: Dec. 4, 2013

Related U.S. Application Data
(60) Provisional application No. 61/733,715, filed on Dec. 5, 2012.

(51) Int. Cl. B31B 17/00

(52) U.S. Cl. CPC B31B 17/00
USPC 493/114

(57) ABSTRACT

A carton forming machine has a forming assembly, a first carton dispenser, and a second carton dispenser. The forming assembly includes a forming head and a plurality of forming stations including a first forming station and a second forming station. The forming head has an axis of travel along which it moves to form a carton from multiple carton blanks. The first forming station is aligned with the second forming station along the axis of travel, and the forming head travels through the first and second forming stations.

### CROSS-REFERENCE TO RELATED APPLICATIONS

This Application claims the benefit of and priority to U.S. Provisional Application No. 61/733,715, filed Dec. 5, 2012, which is incorporated by reference.

### STATEMENT REGARDING FEDERALLY SPONSORED RESEARCH

Not Applicable.

### BACKGROUND OF THE INVENTION

Carton forming machines of various varieties are known in the art. Known types of carton forming machines, however, are ill-suited to form a carton having more than a single layer of material or more than a single carton blank. In particular, existing methods of making a carton from multiple carton blanks involve forming a second carton blank around a pre-formed carton in a separate process. Therefore, there remains a need in the art for a forming machine that can form a carton from multiple carton blanks in a single process.

All U.S. patents and applications and all other published documents mentioned anywhere in this application are incorporated herein by reference in their entirety. Applicants specifically incorporate by reference U.S. Pub. No. 2011/0319241, filed Jun. 23, 2011, entitled Pizza Tray and Forming Assembly, having inventors Thomas Partridge, David Belden, and Matthew Mate', and application Ser. No. 13/167560.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF DESCRIPTION OF THE SEVERAL VIEWS OF THE DRAWING(S)

FIG. 1 shows an embodiment of the carton forming machine.

FIG. 2 shows an embodiment of a first carton dispenser prior to loading a first carton blank on the first shuttle bed.

FIG. 3 shows a first carton dispenser advancing from the configuration shown in FIG. 2.

FIG. 4 shows a first carton dispenser placing a first carton blank on a first shuttle bed.

FIG. 5 shows a first carton dispenser having a shuttle engaged to first carton blank.

FIG. 6 shows a first carton dispenser and a portion of a forming assembly, wherein a first carton blank is being moved onto the forming assembly.

FIG. 7 shows a first carton dispenser and a portion of a forming assembly, including a forming head.

FIG. 8 shows a side view of the carton forming machine of the embodiment of FIG. 1.

FIG. 9 shows a detailed side view of a portion of the carton forming machine of FIG. 8.

FIG. 10 shows a detailed view of a portion of the forming assembly.

FIG. 11 shows a portion of the forming assembly with a forming head moving through a first forming station.

FIG. 12 shows a portion of the forming assembly with a forming head moving through a second forming station.

FIG. 13 shows a carton track assembly.

FIG. 14 shows a detailed view of a pallet.

FIG. 15 shows a detailed view of a forming head.

FIG. 16 shows a detailed view of a first forming station.

FIG. 17 shows a detailed view of a second forming station.

FIG. 18 shows a schematic view of the carton forming machine.

### DETAILED DESCRIPTION OF THE INVENTION

In order to alleviate the problems associated with existing methods for forming a carton from multiple carton blanks, a carton forming machine, as disclosed herein, uses a single mandrel to form the carton from multiple carton blanks. This yields a superior finished carton when compared to known processes since the mandrel is rigid and the dimensions of the mandrel are consistent. Further, when compared to known forming processes, use of a single mandrel involves fewer components, reducing cost. Finally, the carton forming machine, as descried herein, can produce cartons more quickly than known methods of forming a secondary material around an existing carton, for example.

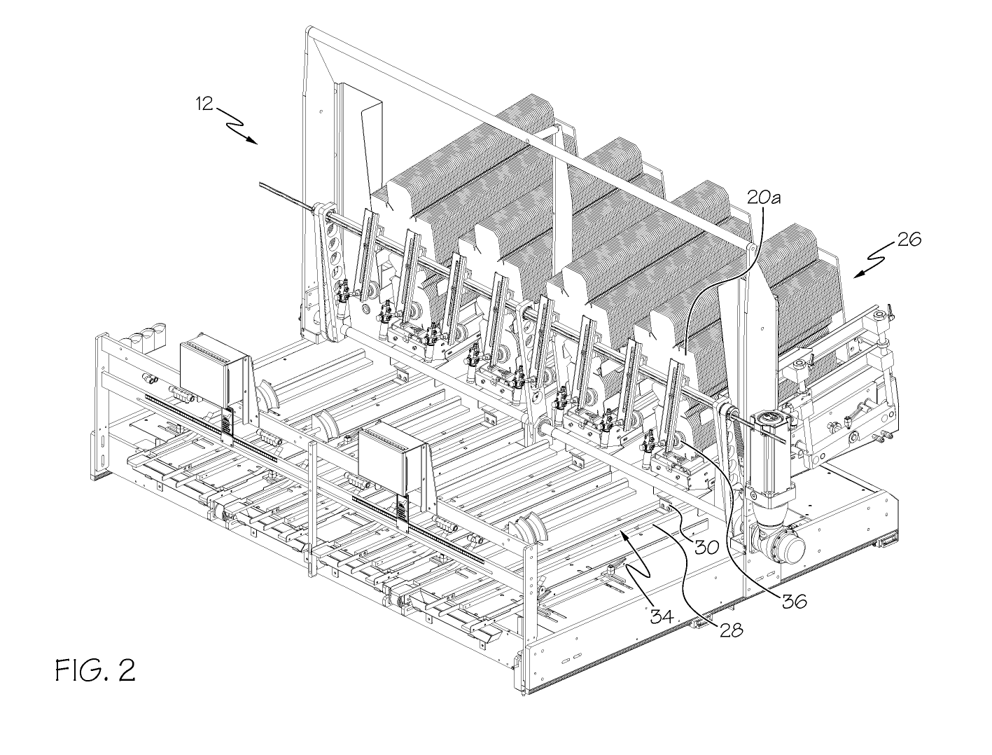

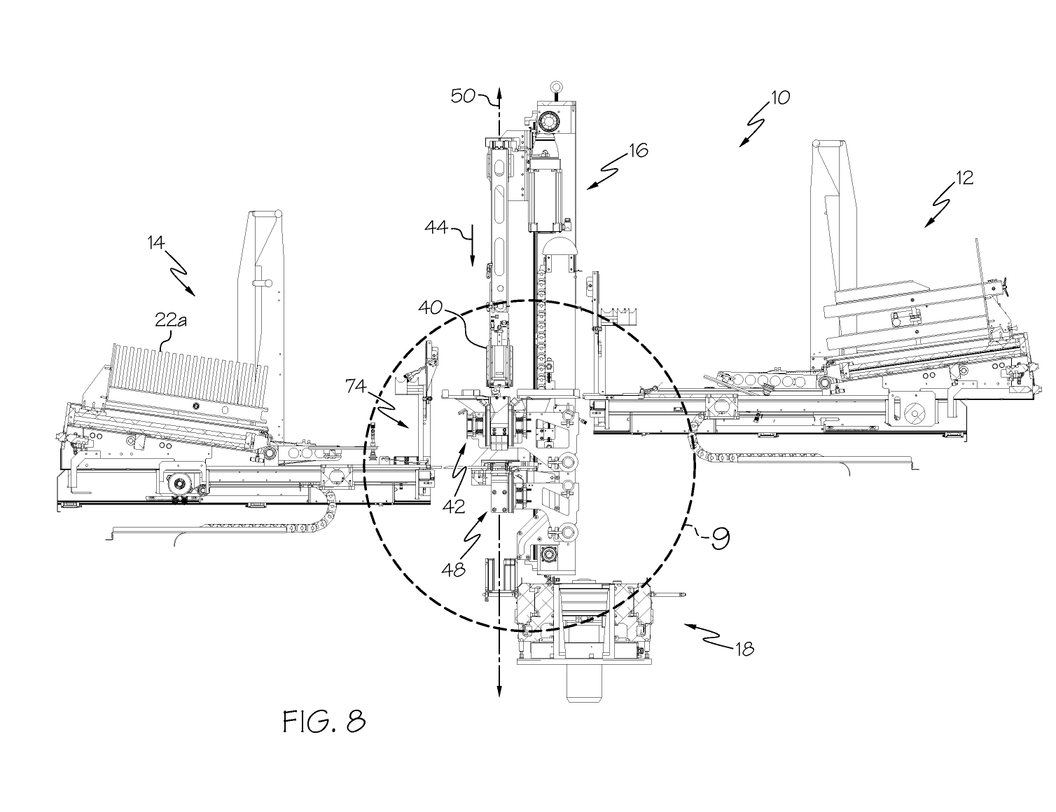

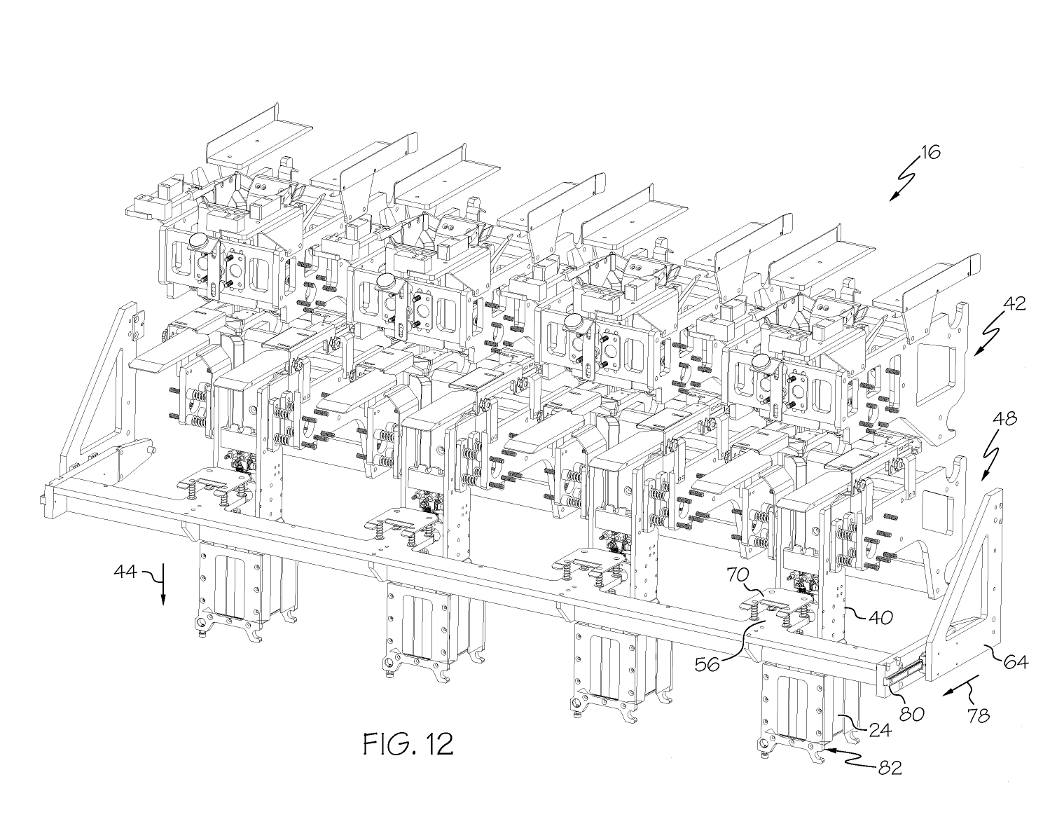

A carton forming machine 10 comprises a first carton dispenser 12, a second carton dispenser 14, and a forming assembly 16. In some embodiments, the carton forming machine 10 further includes a carton track assembly 18. Generally, a first carton dispenser 12 dispenses a first carton blank 20a (FIG. 2), which is loaded into the forming assembly 16. Additionally, the second carton dispenser 14 dispenses a second carton blank 22a (FIG.8), which is loaded into the forming assembly 16. The forming assembly 16 forms the first and second carton blanks 20a and 22a into an assembled carton 24 (FIG. 12).

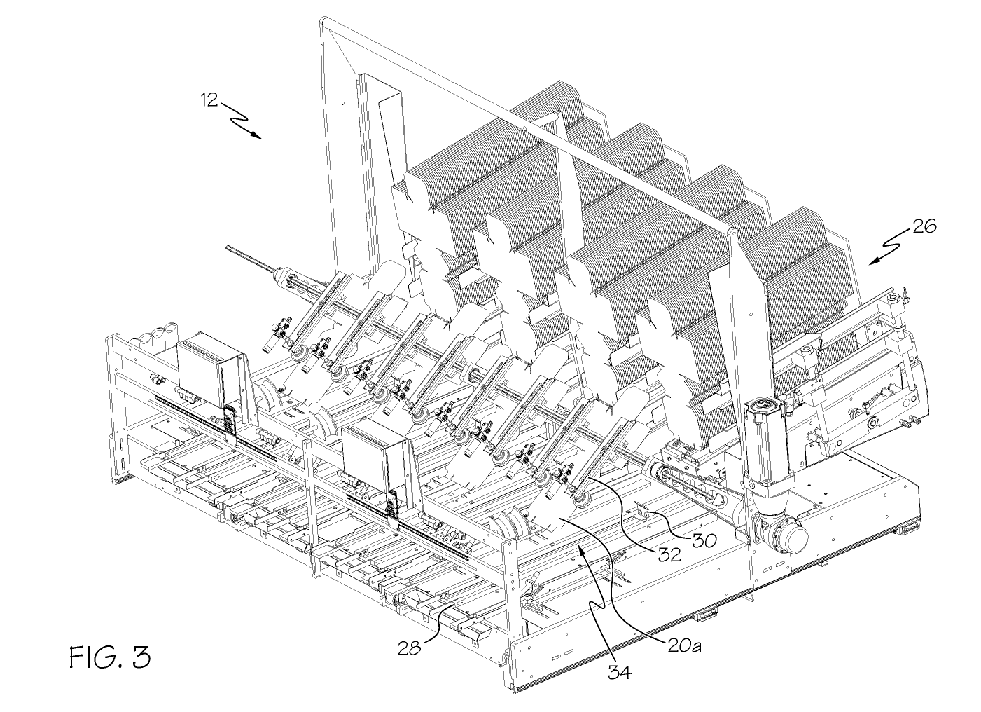

Turning to FIG. 2, a first carton dispenser 12 is shown with a plurality of first carton blanks 20a disposed in a first dispenser magazine 26. The first carton dispenser 12 comprises a first shuttle bed 28, a first shuttle 30, a blank pick arm 32, and a first dispenser magazine 26. Upon actuation, the blank pick arm 32 picks up the first carton blank 20a from the first dispenser magazine 26 and places it on the first shuttle bed 28 at blank drop zone 34, for example as shown in FIG. 3. In some embodiments, two blank pick arms 32 are used to pick up the first carton blank 20a, for example as shown in FIGS. 2 and 3.

In some embodiments, the blank pick arm 32 picks up the first carton blank 20a from the first dispenser magazine 26 with a vacuum source (not shown) and suction cup 36. It will be appreciated that other methods of picking up the carton blank 20a can also be used.

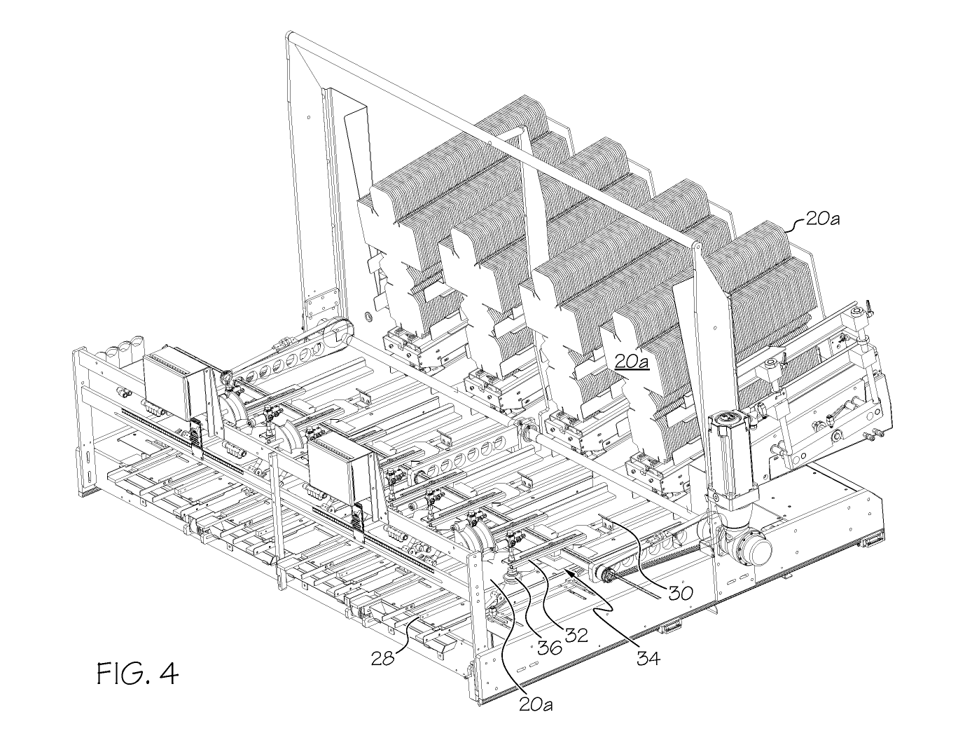

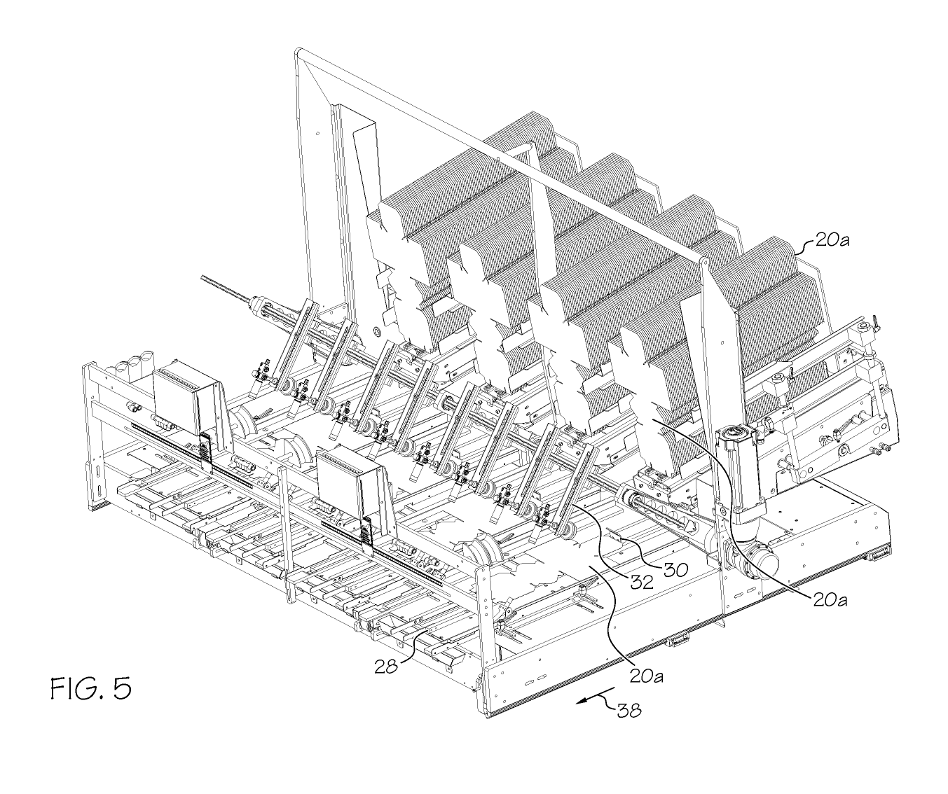

With regard to FIG. 4, the blank pick arm 32 moves to the blank drop zone 34 to place the first carton blank 20a on the first shuttle bed 28. Subsequently, as shown in FIG. 5, the blank pick arm 32 releases the first carton blank 20a. Also as shown in FIG. 5, the first shuttle 30 engages the first carton blank 20a as the blank pick arm 32 releases the first carton blank 20a. Upon release of the first carton blank 20a, the blank pick arm 32 returns to pick up another carton blank 20a from the first dispenser magazine 26. Additionally, the first shuttle 30 moves in the direction of directional arrow 38 to contact the first carton blank 20a, as illustrated, for example, in FIG. 5.

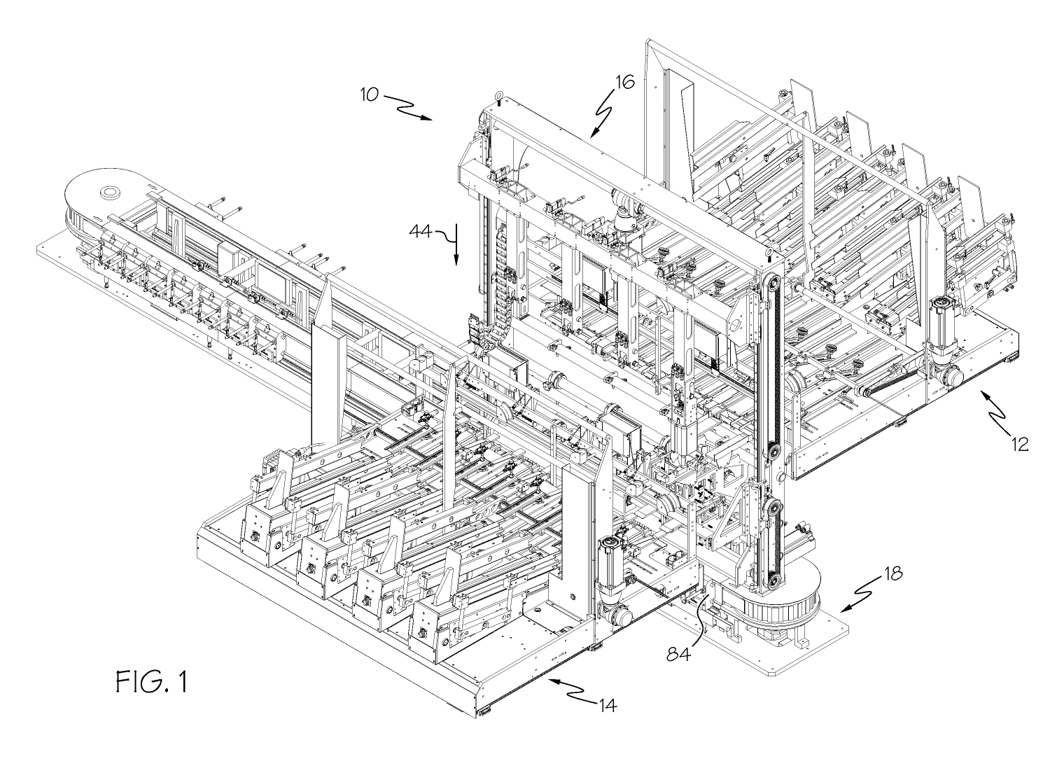

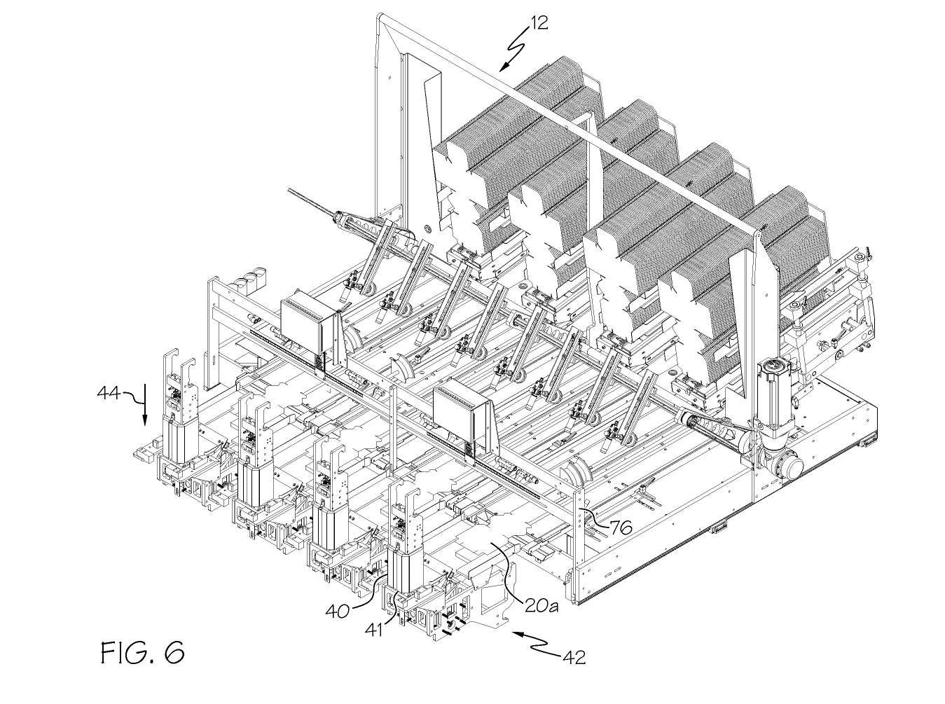

Turning to FIG. 6, the first shuttle 30 pushes the first carton blank 20a onto the first forming station 42. The first forming station 42 is a portion of the forming assembly 16 (FIG. 1), and the first forming station 42 is adjacent to the first carton dispenser 12. The forming assembly 16 further comprises a forming head 40 which moves in the direction of arrow 44 (FIGS. 1 and 6) to form the first carton blank 20a around the mandrel 41; in this way the first carton blank 20a is formed into a carton. As shown in FIG. 6, the first shuttle 30 is in transit. As the first shuttle 30 pushes the first carton blank 20a toward the first forming station 42, adhesive, for example hot-melt glue, is applied to specified surfaces of the first carton blank 20a. In some embodiments, the glue is applied at a first glue station 76. As the first carton blank 20a is folded, the glue holds the carton together. As discussed in greater detail below, the carton can also be held together in other ways.

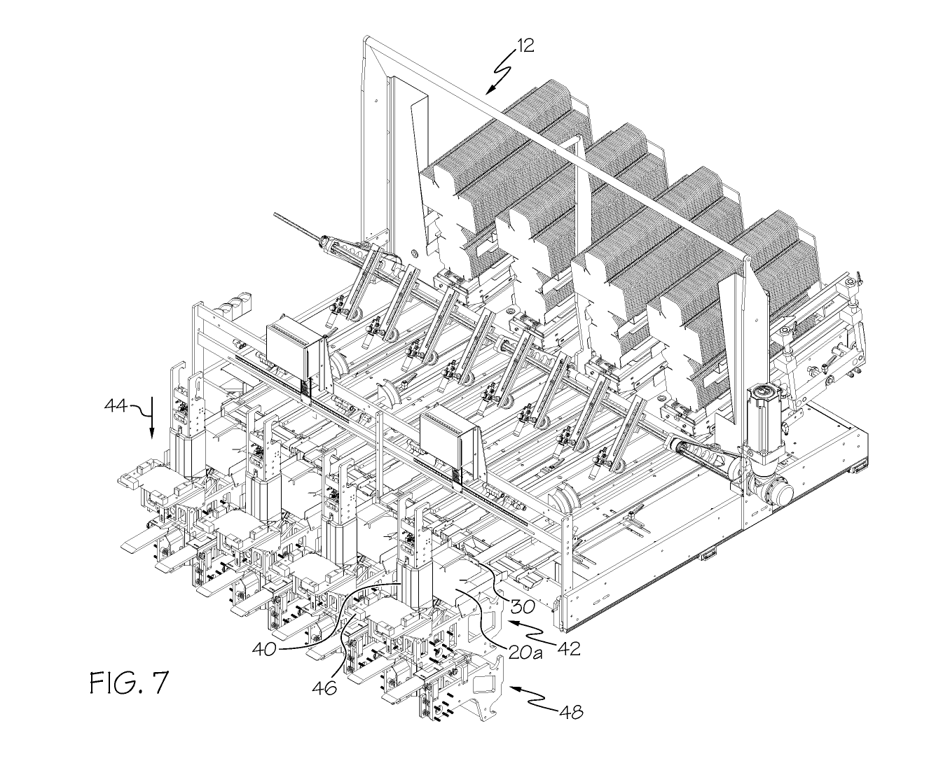

In FIG. 7, the first shuttle 30 has pushed the carton blank 20a against first carton stop 46 and into the forming position. Additionally, the forming head 40 has moved in the direction of arrow 44 toward the carton blank 20a. As this juncture, the carton blank 20a is ready to be formed into a carton via the forming head 40 and first forming station 42.

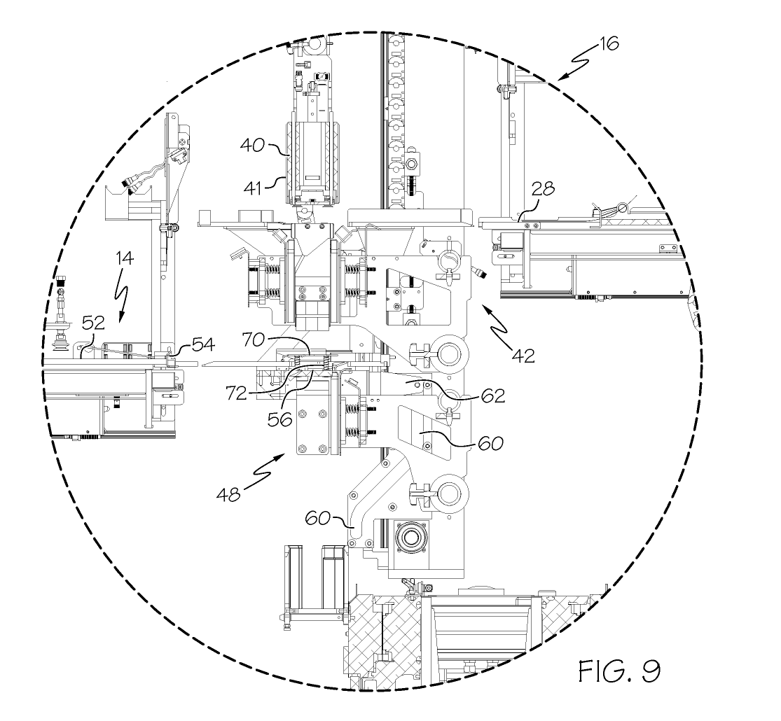

The process to form the carton from carton blank is further illustrated in FIGS. 8 and 9. FIG. 8 is a side-view of the carton forming machine 10. As shown, the first forming station 42 is located above a second forming station 48 such that as the forming head 40 moves along axis of travel 50, it passes through both the first and second forming stations 42, 48. In this way, the carton forming machine 10 can form a carton made from two carton blanks. As described above, the first carton blank 20a is loaded onto the forming assembly 16 via the first carton dispenser 12. In turn, the second carton blank 22a is loaded onto the forming assembly 16 via the second carton dispenser 14.

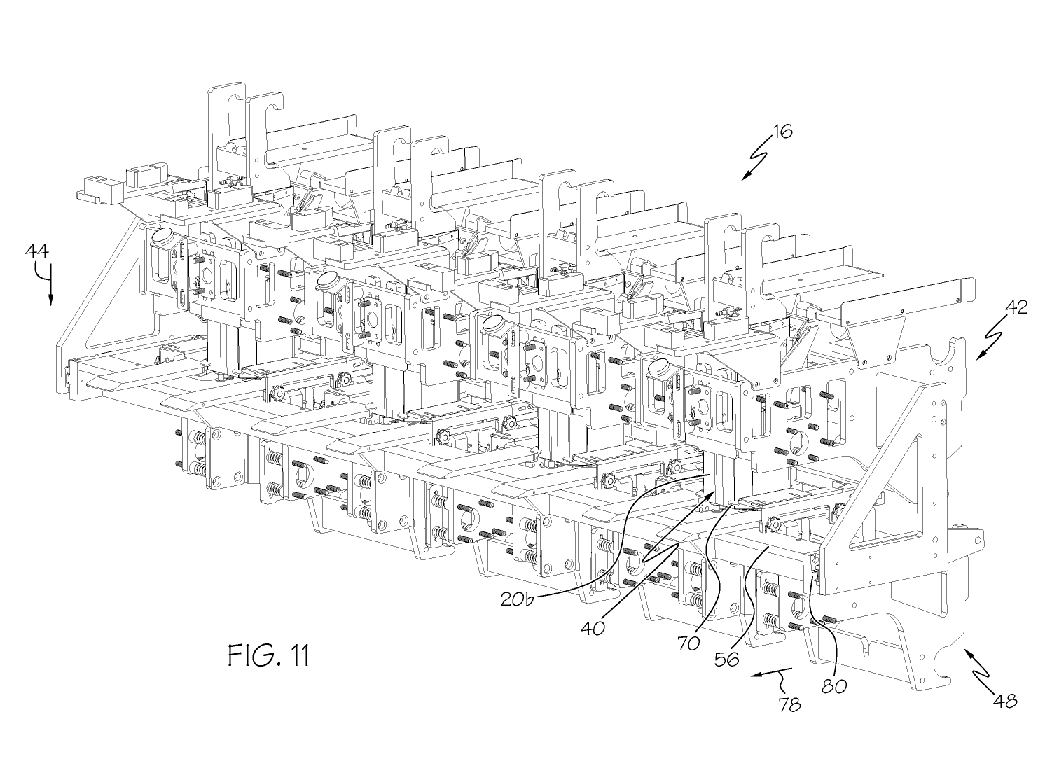

In some embodiments, the second carton dispenser 14 dispenses second carton blanks 22a in the same matter as the first carton dispenser 12 dispenses first carton blanks 20a. In particular, the second carton dispenser 14 places the second carton blank 22a on the second forming station 48. It will be appreciated that the second carton blank 22a can be a different shape than the first carton blank 20a. Or, the second carton blank 22a can be the same shape as the first carton blank 20a, for example where the assembled carton 24 is double-walled on all sides. Further, where the second carton blank 22a is configured to fit over the outside of a first formed carton 20b (FIG. 11), the relevant inner dimensions of a second formed carton (not shown) are slightly larger than the relevant outer dimensions of the first formed carton 20b, such that at least a portion of the first formed carton 20b fits within at least a portion of the second formed carton.

In some embodiments, for example as shown in FIG. 8, the first carton dispenser 12 and the second carton dispenser 14 are located on opposite sides of the forming assembly 16. In some embodiments, however, the first carton dispenser 12 and the second carton dispenser 14 are located on the same side of the forming assembly 16.

Returning to FIG. 7, as the forming head 40 moves in the direction of arrow 44, the forming head 40 pushes the first carton blank 20a through the first forming station 42. The sides of the first carton blank 20a are folded with the first forming station 42 and the first carton blank 20a thereby takes on the shape of a carton.

The components used in the forming process can be seen with additional detail in FIG. 9. Here, the second carton dispenser 14 is shown with second shuttle bed 52, along which the second shuttle 54 transports the second carton blank 22a to the second forming station 48.

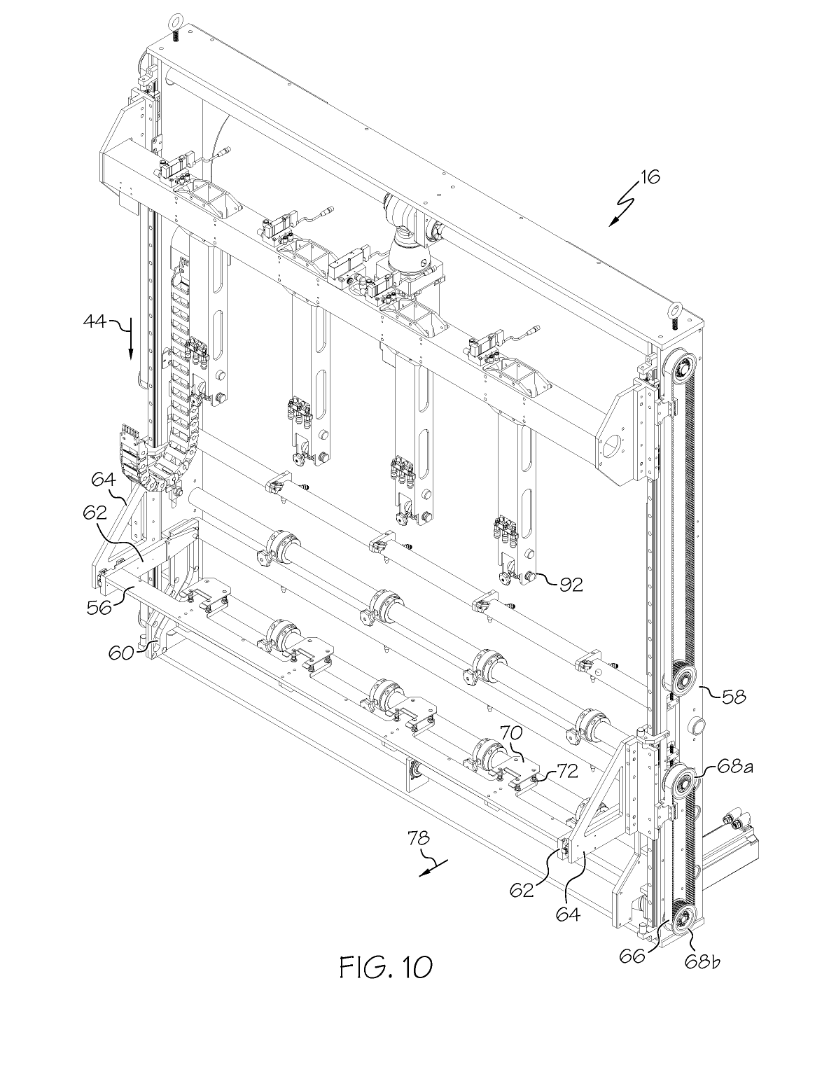

With further reference to FIG. 9, in some embodiments, the forming assembly 16 further comprises a compression shelf 56. As also shown in FIG. 10, the compression shelf 56 is moveable with respect to the main frame 58 of the forming assembly 16. In particular, where used, the compression shelf 56 moves along track 60. The compression shelf 56 has arms 62 extending therefrom. The arms 62, in turn, have a bearing (not shown) that moves within the track 60. Additionally, the arms 62 are attached to brace members 64 via a linear slide rail 80 (FIG. 11) which, in some embodiments, acts like the slide on a drawer. Further, the brace member 64 is connected to belt 66. It will be appreciated that the belt 66 is moved with one or both of pulleys 68a and 68b. It will further be appreciated that in place of belt 66, a chain or other drive mechanism can also be used.

In some embodiments, the compression shelf 56 comprises a compression plate 70 attached thereto. The compression plate 70 is suspended on one or more resilient members 72, for example coil springs.

For the sake of clarity, the forming head 40 is not shown in FIG. 10. It will nonetheless be appreciated that the forming head 40 is attached, for example, to the mast 92, for example as shown in FIG. 1. Further, the mast 92, along with the upper portion of the forming assembly 16 has been omitted from FIGS. 6, 7, 11, and 12.

Turning now to FIG. 11, the forming head 40 is shown having moved through the first forming station 42. At this juncture, the forming head 40 is at least partially surrounded by the first formed carton 20b. Moreover, as the forming head 40 progresses in the direction of arrow 44, the forming head 40, at least partially surrounded by the first formed carton 20b, contacts the second carton blank 22a (FIG. 8). Moving further in the direction of arrow 44, the forming head 40 pushes the second carton blank 22a against the compression plate 70, which is suspended above the compression shelf 56 by way of resilient members 72. The compression plate 70 provides a limited amount of resistance against the first formed carton 20b in order to ensure that the first formed carton 20b is properly pressed against the second carton blank 22a before the second carton blank 22a, along with forming head 40 and first formed carton 20b, enter the second forming station 48.

In some embodiments, glue, for example hot-melt glue, is applied to the second carton blank 22a before the second carton blank 22a is positioned over the second forming station 48. The glue is thereby used to attach an inside surface of the second carton blank 22a to an outside surface of the first formed carton 20b. With reference to FIG. 8, the glue can be applied for example at second glue station 74. Glue can also be applied to specified surfaces of the second carton blank 22a in order to adhere portions of the second carton blank 22a to other portions of the second carton blank 22a.

Returning to FIG. 11, after the forming head 40 and first formed carton 20b have contacted the second carton blank 22a, the forming head 40 continues in the direction of arrow 44, thereby pushing the second carton blank 22a through the second forming station 48. As the forming head 40 moves through the second forming station 48, the compression shelf 56 moves, at first, in the direction of arrow 44, along track 60 (FIGS. 9 and 10). Eventually, as the brace member 64 continues in the direction of arrow 44, the compression shelf 56 begins to move in the direction of arrow 78 relative to the brace member 64 (FIGS. 10 and 11). In some embodiments, the compression shelf 56 moves along linear slide rail 80. The movement of the compression shelf 56 relative to the brace member 64 is determined by the track 60. Therefore, as the forming head 40 makes its way through the second forming station 48, the compression shelf 56 begins to move away from the forming head 40.

As shown in FIG. 12, the forming head 40 has moved through the second forming station 48. Upon moving through the second forming station 48, the forming head 40 deposits the assembled carton 24 in the pallet 82. As further shown in FIG. 12, the compression shelf 56 has moved relative to brace member 64 in the direction of arrow 78.

After depositing the assembled carton 24 in the pallet 82, the forming head 40 moves in the direction opposite arrow 44, returning to the position shown in FIG. 9. Additionally, the pulleys 68a and 68b (FIG. 10) reverse direction and the brace member 64 moves in the direction opposite arrow 44 and the compression shelf 56 retracts, moving in a direction opposite arrow 78.

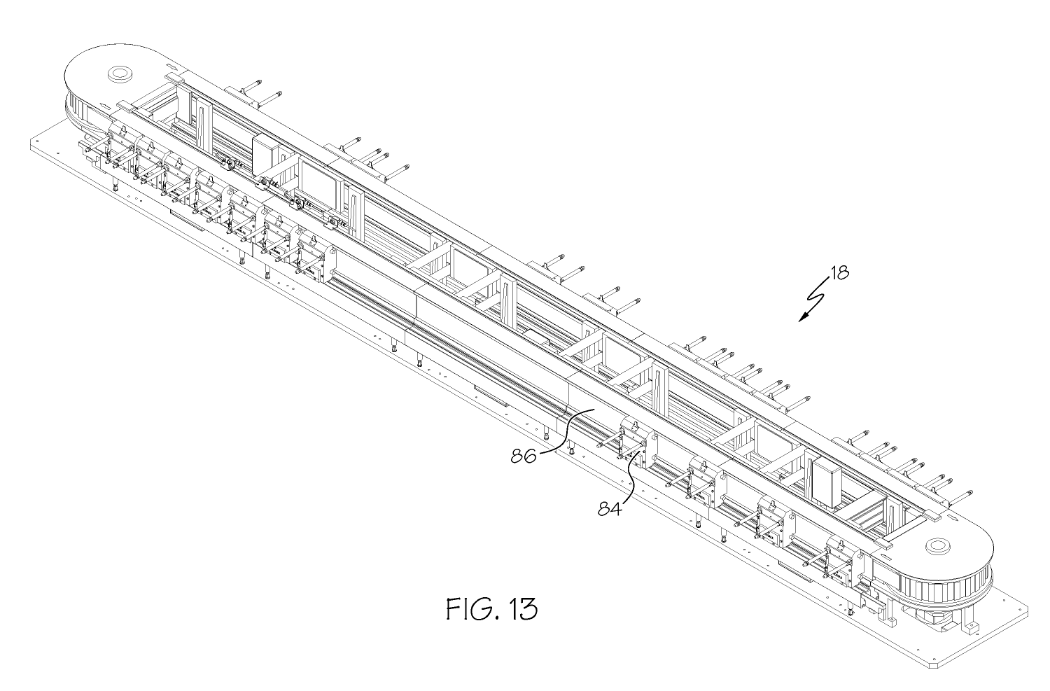

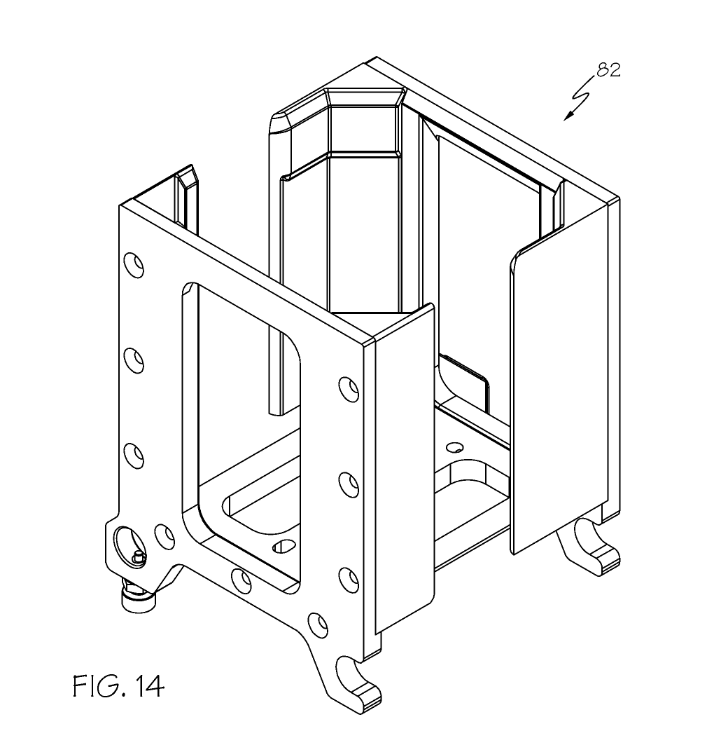

The pallet 82 is carried by pallet carrier 84, as shown in FIG. 1. The pallet carrier 84, in turn, is moveable along the carousel 86, as shown in FIG. 13. After the assembled carton 24 is deposited within the pallet 82, the carousel 86 carries the pallet 82 and assembled carton 24 away from the forming assembly 16 (FIG. 1) where the assembled carton 24 is removed from pallet 82. The pallet 82 can then circulate around carousel 86 to be refilled with another assembled carton 24. The pallet 82 is shown in more detail in FIG. 14.

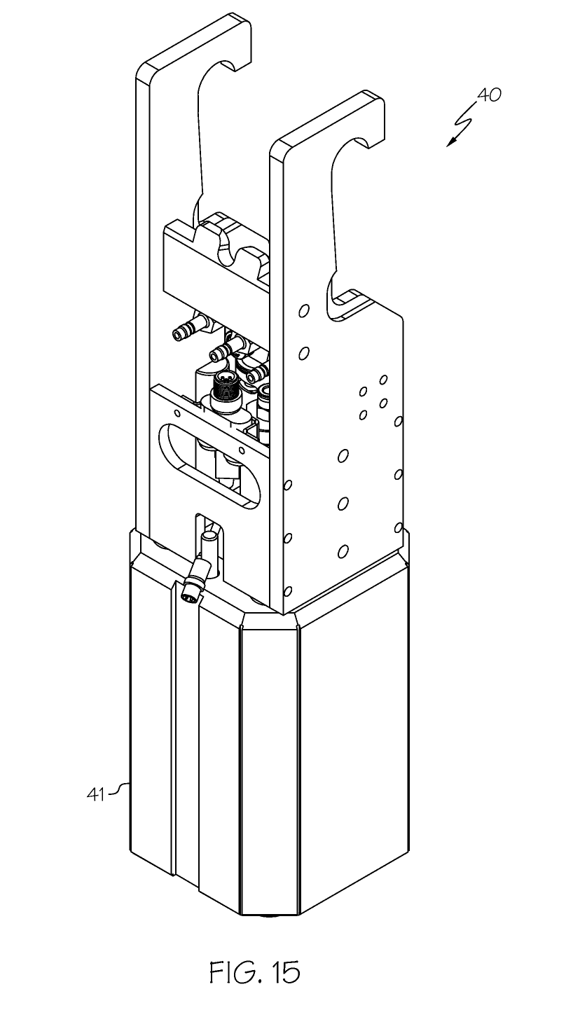

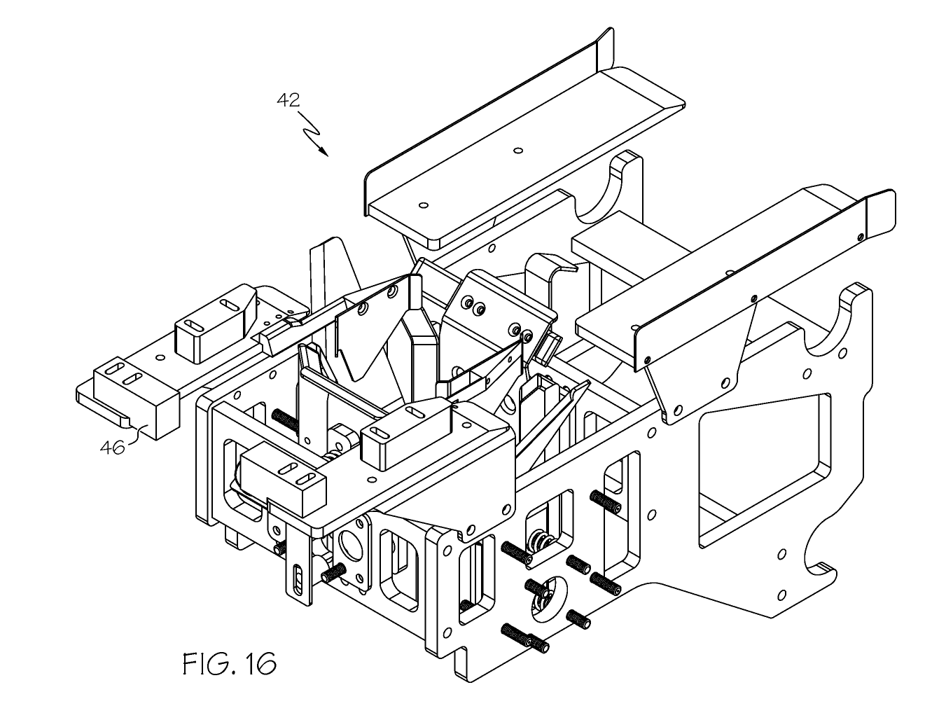

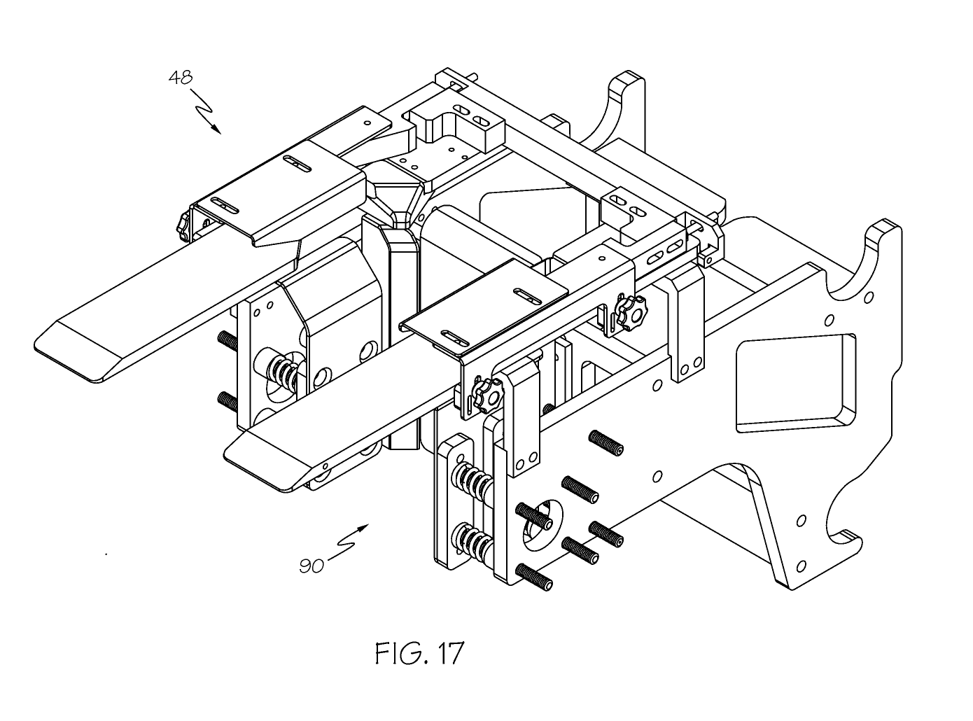

Further, the forming head 40 is shown in additional detail in FIG. 15; the first forming station is shown in greater detail in FIG. 16 and the second forming station 48 is shown in greater detail in FIG. 17. As will be appreciated by the skilled artisan, the first and second forming stations 42, 48 have appropriately placed stops (e.g., first carton stop 46), plates, and contoured surfaces in order to properly form the first and second carton blanks 20a, 22a into their respective formed cartons (e.g., first formed carton 20b). In some embodiments, the second forming station 48 has an opening 90 so that the compression plate 70 (FIG.9) can pass through the opening 90.

Moreover, although shown in the attached figures with two forming stations, the carton forming machine 10 can have any suitable number of forming stations. For example, if the carton is desirably formed from three carton blanks, the carton forming machine 10 can have three forming stations. The carton forming machine 10 can also have between four and eight forming stations, though any suitable number of forming stations can be used.

As discussed previously, in some embodiments, the carton is held together with a hot-melt glue. Nonetheless, other adhesives, for example a heat activated adhesive, can be used. Such a heat activated adhesive can be applied to the carton blank prior to placement of the carton blank in the carton dispenser. Then, heat can be applied to the heat activated adhesive before, during, or after the carton blank is formed into a carton. Further, the carton can have locking flaps or tabs. The carton can further have a combination of locking flaps or tabs and an adhesive.

Although the forming assembly 16 is shown in many of the attached figures as having four adjacent forming heads 40, any number of forming heads 40 is suitable. For example, the forming assembly 16 can have only a single forming head 40. The forming assembly 16 can also comprise 2-10 forming heads 40, though any suitable number of forming heads can be used. Further, it will be appreciated that the first and second carton dispensers 12, 14 can have any suitable number of dispenser magazines, shuttles, etc. And, the carton track assembly 18 can comprise any suitable number of pallets 82 and pallet carriers 84.

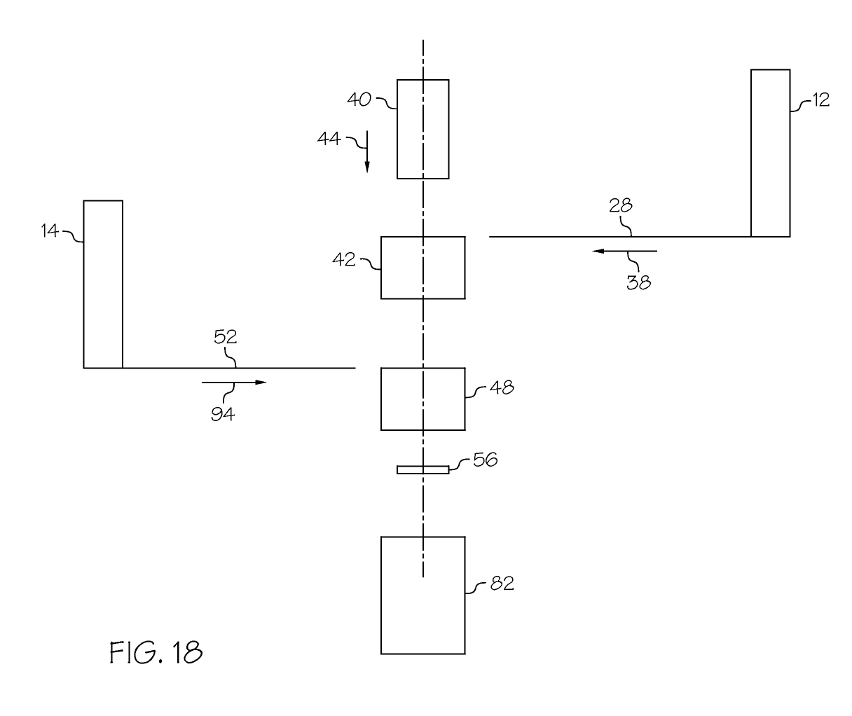

With regard to FIG. 18, a schematic of the carton forming machine 10 is shown therein. The direction of travel of the first shuttle 30 (FIG. 2) is shown via directional arrow 38, wherein the first shuttle 30 moves the first carton blank 20a into position on the first forming station 42. Similarly, the direction of travel of the second shuttle 54 (FIG. 9) is shown via directional arrow 94, wherein the second shuttle 54 moves the second carton blank 22a into position on the second forming station 48. The forming head 40 then moves in the direction of arrow 44, moving through the first forming station 42 and, subsequently, through the second forming station 48. The compression shelf 56 leads the forming head 40 in the direction of arrow 44 starting at the second forming station 48. Then, the compression shelf 56 moves out of the way of forming head 40 so that the forming head 40 can deposit the assembled carton 24 (FIG. 12) in pallet 82. It will be appreciated that the assembled carton 24 includes both a first carton/first carton blank 20a and a second carton/second carton blank 22a.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A carton forming machine comprising:
a forming assembly, the forming assembly comprising a forming head and a plurality of forming stations including a first forming station and a second forming station;
the forming head having an axis of travel, the first forming station being aligned with the second forming station along the axis of travel;
wherein the forming head is moveable along the axis of travel through the first and second forming stations.

2. The carton forming machine of claim 1 further comprising a first carton dispenser and a second carton dispenser.

3. The carton forming machine of claim 2, wherein the first carton dispenser is located on a first side of the forming assembly and the second carton dispenser is located on a side of the forming assembly opposite the first side.

4. The carton forming machine of claim 3, wherein each of the first and second carton dispensers comprise a blank pick arm.

5. The carton forming machine of claim 1, wherein the forming assembly further comprises a compression shelf, the compression shelf having a compression plate attached thereto.

6. The carton forming machine of claim 5, wherein the compression plate is attached to the compression shelf via at least one resilient member.

7. The carton forming machine of claim 6, wherein the resilient member is a coil spring.

8. The carton forming machine of claim 1 further comprising a carton track assembly.

9. The carton forming machine of claim 8, wherein the carton track assembly comprises at least one pallet configured for receipt of a carton therein.

10. The carton forming machine of claim 9, wherein the at least one pallet is moveable along the carton track assembly.

11. The carton forming machine of claim 9 further comprising at least one pallet carrier, the pallet carrier configured to retain the pallet and move the pallet along the carton track assembly.
